(19) United States
(12) Patent Application Publication
(10) Pub. No.: US 2014/0297942 A1
(43) Pub. Date: Oct. 2, 2014

(54) DATA CACHE FOR A STORAGE ARRAY

(71) Applicant: HEWLETT-PACKARD DEVELOPMENT COMPANY, L.P., Houston, TX (US)

(72) Inventors: Nathaniel S. DeNeui, Houston, TX (US); Tod D. Rushton, Tomball, TX (US); Joseph David Black, Houston, TX (US)

(73) Assignee: Hewlett-Packard Development Company, L.P., Houston, TX (US)

(21) Appl. No.: 13/852,179

(22) Filed: Mar. 28, 2013

(51) Int. Cl. G06F 3/06

(52) U.S. Cl. CPC G06F 3/0689; G06F 3/0646; G06F 3/0607
USPC 711/114

(57) ABSTRACT

Embodiments of the present disclosure provide for a storage system that includes an array of disk drives and a controller communicatively coupled to the array of disk drives. The controller includes a dual purpose cache. The controller is configured to perform maintenance operations and host input/output (I/O) operations using the dual purpose cache.

### BACKGROUND

A redundant array of independent disks (RAID) may undergo input/output (I/O) operations from a host computer and maintenance operations for disks in the RAID.

### BRIEF DESCRIPTION OF THE DRAWINGS

Certain exemplary embodiments are described in the following detailed description and in reference to the drawings, in which:

FIG. 1 is a block diagram of a storage system for operating a redundant array of independent disks (RAID);

FIG. 2 is a block diagram illustrating performing operations in a RAID, in accordance with embodiments;

FIG. 3 is a process flow diagram of a method for performing operations in a RAID, in accordance with embodiments; and

FIG. 4 is a block diagram showing a tangible, non-transitory, computer-readable medium that stores code configured to perform operations in a RAID, in accordance with embodiments.

### DETAILED DESCRIPTION OF SPECIFIC EMBODIMENTS

As explained above, a redundant array of independent disks (RAID) may undergo input/output (I/O) operations from a host computer and maintenance operations for disks in the RAID. These operations are performed by a controller that includes a write data cache for host I/O operations and a discrete buffer for maintenance operations. Host I/O operations and maintenance operations cannot be performed concurrently. For example, the write data cache used for host I/O operations may be disabled when the RAID is performing a maintenance operation. As disk drives increase in size, managing these operations becomes increasingly difficult and time consuming, as host I/O operations and maintenance operations can come into conflict and block each other from accessing data stored on disk, thus slowing down performance.

The present disclosure relates to performing operations in a redundant array of independent disks (RAID). In accordance with embodiments, a RAID controller can perform maintenance operations using a dual purpose cache that is also used for host input/output (I/O) operations, thus eliminating the need to use a discrete buffer for maintenance operations, and allowing both host I/O operations and maintenance operations to be performed simultaneously. The system and method disclosed herein improves the speed and efficiency of performing operations in the RAID controller with host I/O.

As used herein, host I/O operations refer to operations in which a host processor communicatively coupled to the RAID controller either reads data stored on a disk array, or writes data to a disk array. As used herein, maintenance operations refer to operations that relate to or affect the redundant storage of data. Maintenance operations can include rebuild operations, transformation operations, and initialization operations.

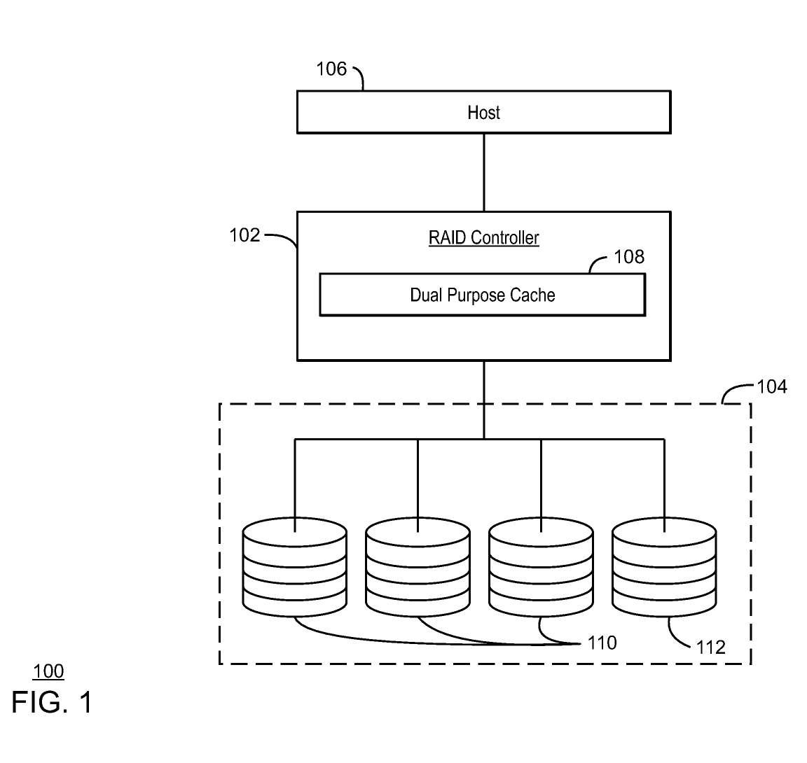

FIG. 1 is a block diagram of a storage system for operating a redundant array of independent disks (RAID). The storage system 100 can include a RAID controller 102 configured to operate an array of disk drives 104. The storage system 100 can also include a host 106 that can access the array of drives 104 through the RAID controller 102. The host 106 can be an electronic device with a processor such as a desktop computer, a laptop computer, a tablet, or a mobile device. The RAID controller 102 can include a dual purpose cache 108 that can be used by the RAID controller 102 to perform both maintenance operations and host I/O operations.

The array of disk drives 104 may include one or more disk drives 110. In some embodiments, the array of disk drives 104 includes a parity drive 112. Each of the disk drives 110 is configured to store data that can be accessed by the RAID controller 102. The data stored in the disk drives 110 can be loaded onto the dual purpose cache 108.

The parity drive 112 can contain data or logic that can be used to regenerate data should a disk drive 110, or a portion of a disk drive 110, fail. The data in the parity drive 112 can recreate lost data based on existing data remaining of disk drives 110 that are still functional.

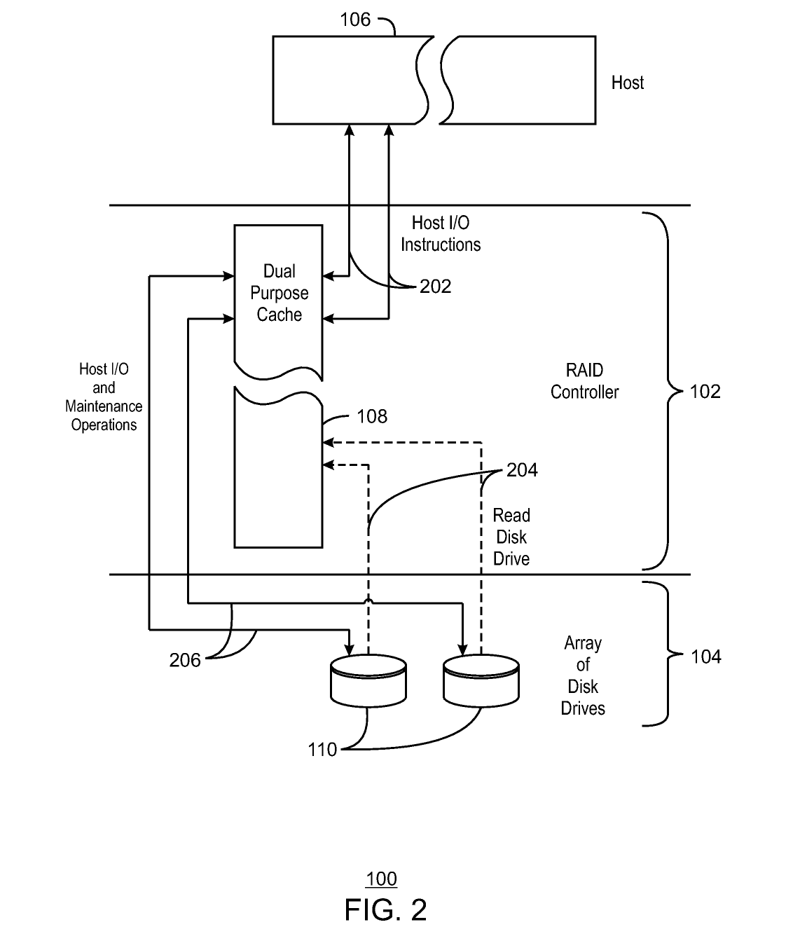

FIG. 2 is a block diagram illustrating performing operations in a RAID, in accordance with embodiments. Arrows 202 indicate the path of host I/O operations between the host 106 and the dual purpose cache 108. The host 106 may send instructions to the dual purpose cache 108 to read data from a particular location in a disk drive 110 from the array of disk drives 104. The host 106 may also send information to the dual purpose cache 108 to be written at a particular location in a disk drive 110 from the array of disk drives.

Arrows 204 indicate the path of maintenance operations from the array of disk drives 104 to the dual purpose cache 108. During a maintenance operation, a block of data stored in a disk drive 110 in the array of disk drives 104 can be copied and written to the dual purpose cache 108, where the block of data can be accessed by the host 106. The block of data may contain metadata, which may contain identification for the data's logical block address (LBA) as well as special instructions for flushing the data from the cache. The metadata can also contain instructions for how changes made to the block in data in the dual purpose cache 108 are applied to corresponding data stored in the array of disk drives 104. In one example, a block of a data is loaded onto the dual purpose cache 108 from a first disk drive in the array of disk drives 104, and the block of data is to be copied onto a second disk drive in the array of disk drives 104. The metadata for that particular block of data would not only contain the LBA for both disk drives, but also instructions so that changes made to the block of data in the dual purpose cache 108 are also applied to the corresponding block of data in both the first disk drive and the second disk drive in the array of drives 104.

In some embodiments, the storage system 100 can allow for a user to configure various parameters associated with the transfer of data from the array of disk drives 104 to the dual purpose cache 108. The user can configure the parameters by interfacing with the storage system 100 through the host 106. Examples of parameters include the size of the block of data to be stored in the dual purpose cache 108 and the frequency in which the block of data is read.

Arrows 206 indicate the path of both host I/O operations and maintenance operations between the dual purpose cache 108 and the array of disk drives 104. The dual purpose cache 108 allows for host I/O operations and maintenance operations to be performed simultaneously without having to restrict or delay the progression of one operation to facilitate the other. The RAID controller 102 may load a block of data from a disk drive 110 in the array of disk drives 104 into the dual purpose cache 108 for a maintenance operation. During the maintenance operation, the RAID controller 102 can also perform host I/O operations on the block of data in the dual purpose cache 108 while the maintenance operation is working in the data block's logical block address. Upon conclusion of the maintenance operation, the block of data can be flushed from the dual purpose cache 108 to the disk drive 110 in the array of disk drives.

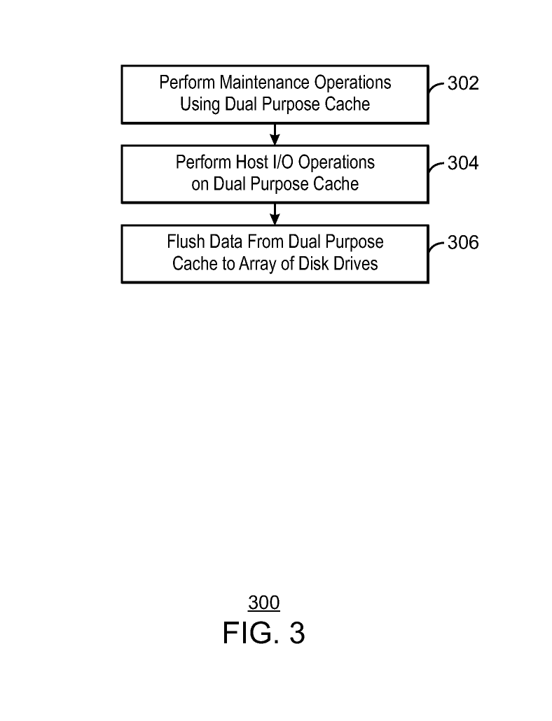

FIG. 3 is a process flow diagram of a method for performing operations in a RAID, in accordance with embodiments. The method 300 can be performed by a RAID controller of a storage system that utilizes an array of disk drives.

At block 302, the RAID controller performs maintenance operations using a dual purpose cache. Maintenance operations can include a rebuild operation, a transformation operation, or an initialization operation.

In a rebuild operation, the RAID controller reads data from a first disk drive or a parity drive to regenerate data in a second disk drive. This type of operation can be used to recover data after a disk drive failure occurs. The portion of the second disk drive that is to be regenerated can be loaded into the dual purpose cache. The data in the first disk drive or parity drive can also be loaded into the dual purpose cache to be read. The RAID controller can use the data or logic contained in the first disk drive or parity drive to determine the content of the data that is to be regenerated. In some embodiments, the RAID controller can rebuild multiple disk drives simultaneously.

In a transformation operation, the RAID controller alters the arrangement of the array of disk drives. The RAID controller may rearrange data segments within the disk drives, or transfer data from one disk drive to another. The data segments that are to be modified can be loaded into the dual purpose cache. The metadata for the data segments can be altered to give them new LBAs.

In an initialization operation, the RAID controller reads data in the array of disk drives to calculate parity data. Parity data contains logic that can be used to regenerate missing data in another disk drive. The parity data can be created and temporarily stored in the dual purpose cache. The parity data can be given an LBA such that when the parity data is flushed, it is written into a parity drive in the array of disk drives.

At block 304, the RAID controller performs host I/O operations on the dual purpose cache. The host I/O operations may occur during maintenance operations, wherein the RAID controller is concurrently modifying data in the array of disk drives. In some embodiments, the RAID controller reads a data block that has been loaded onto the dual purpose cache from the array of disk drives. In some embodiments, the RAID controller writes data in the dual purpose cache with a specific LBA pointing to a location within the array of disk drives. In some embodiments, the RAID can overwrite a data block that has been loaded onto the dual purpose cache from the array of disk drives. It is to be noted that when flushing a data block in the dual purpose cache, the RAID controller can simply write to the portion of the array of disk drives specified by the data block's LBA, rather than write to every disk drive in the array of disk drives. In other words, the data block can be flushed directly to the LBA(s) indicated by the data block's metadata.

At block 306, the RAID controller flushes the data block from the dual purpose cache to the array of disk drives. This may occur after a maintenance operation has concluded. In some embodiments, the data block has been modified in the dual purpose cache. In some embodiments, the data block has been newly written into the dual purpose cache. The data block stored in the dual purpose cache may contain metadata that identifies the data block's LBA. The metadata can also specify how changes applied to the data block in the dual purpose cache is applied to corresponding data stored in the array of disk drives. The data block is flushed from the dual purpose cache to its corresponding location among the array of disk drives.

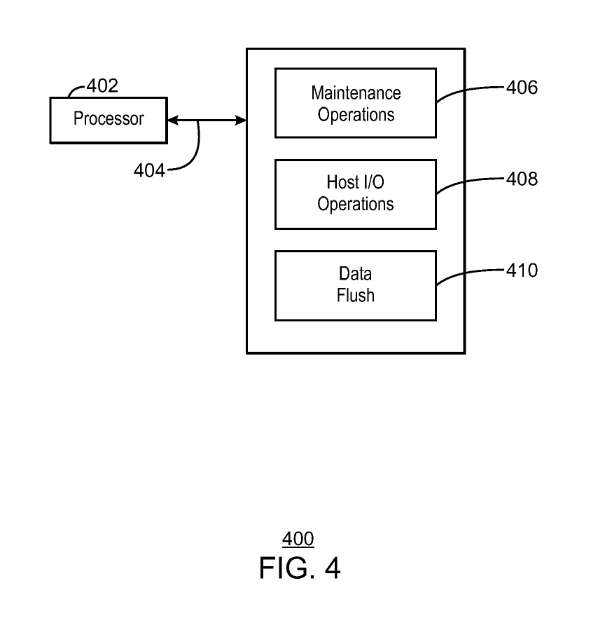

FIG. 4 is a block diagram showing a tangible, non-transitory, computer-readable medium that stores code configured to perform operations in a RAID, in accordance with embodiments. The tangible, non-transitory, computer-readable medium is referred to by the reference number 400. The tangible, non-transitory, computer-readable medium 400 can comprise RAM, a hard disk drive, an array of hard disk drives, an optical drive, an array of optical drives, a non-volatile memory, a universal serial bus (USB) drive, a digital versatile disk (DVD), or a compact disk (CD), among others. The tangible, non-transitory, computer-readable medium 400 may be accessed by a processor 402 over a computer bus 404. Furthermore, the tangible, non-transitory, computer-readable medium 400 may include code configured to perform the methods described herein.

The various software components discussed herein may be stored on the tangible, non-transitory, computer-readable medium 400. A first region 406 on the tangible, non-transitory, computer-readable medium can include a maintenance operations module to perform a maintenance operation using a dual purpose cache. A region 408 can include a host I/O operations module to perform a host I/O operation on the dual purpose cache. A region 410 can include a data flush module to flush data from the dual purpose cache to a disk drive. Although shown as contiguous blocks, the software components can be stored in any order or configuration. For example, if the tangible, non-transitory, computer-readable medium is a hard drive, the software components can be stored in non-contiguous, or even overlapping, sectors.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A storage system, comprising:
an array of disk drives; and
a controller communicatively coupled to the array of disk drives, the controller comprising a dual purpose cache for storing data from the array of disk drives, the controller to perform maintenance operations and host input/output (I/O) operations using the dual purpose cache.

2. The storage system of claim 1, the controller to load a block of data from a first disk drive in the array of disk drives into the dual purpose cache.

3. The storage system of claim 2, the controller to flush the block of data from the dual purpose cache to the first disk drive in the array of disk drives.

4. The storage system of claim 2, the controller to flush the block of data from the dual purpose cache to a second disk drive in the array of disk drives.

5. An array controller communicatively coupled to an array of disk drives, the array controller comprising a dual purpose cache for storing data from the array of disk drives, the array controller to perform host maintenance operations and host input/output (I/O) operations using the dual purpose cache.

6. The array controller of claim 5, to load a block of data from a first disk drive in the array of disk drives into the dual purpose cache.

7. The array controller of claim 6, to flush the block of data from the dual purpose cache to the first disk drive in the array of disk drives.

8. The array controller of claim 6, to flush the block of data from the dual purpose cache to a second disk drive in the array of disk drives.

9. A method for performing operations in an array of disk drives, comprising:
performing maintenance operations using a dual purpose cache; and
performing host input/output (I/O) operations on the dual purpose cache.

10. The method of claim 9, wherein performing the maintenance operations comprises performing a rebuild operation.

11. The method of claim 9, wherein performing the maintenance operations comprises performing a transformation operation.

12. The method of claim 9, wherein performing the maintenance operations comprises performing an initialization operation.

13. The method of claim 9, comprising loading a data block from a first disk drive in the array of disk drives to the dual purpose cache.

14. The method of claim 13, comprising performing a read operation on the data block in the dual purpose cache.

15. The method of claim 13, comprising performing a write operation on the data block in the dual purpose cache.

16. The method of claim 13, comprising flushing the data block from the dual purpose cache to the first disk drive in the array of disk drives.

17. The method of claim 13, comprising flushing the data block from the dual purpose cache to a second disk drive in the array of disk drives.

18. The method of claim 9, comprising configuring a parameter.

19. The method of claim 9, wherein the parameter is size of a data interval.

20. The method of claim 9, wherein the parameter is read frequency of data intervals.
